(19) United States
(12) Patent Application Publication
(10) Pub. No.: US 2017/0200195 A1
(43) Pub. Date: Jul. 13, 2017

(54) METHOD AND SYSTEM FOR ENABLING A USER OF A MULTI-USER TRANSPORTATION SYSTEM TO INITIATE A TRANSACTION FOR AT LEAST ONE OF A GOOD AND A SERVICE OFFERED BY A THIRD PARTY AND USE THEREOF

(71) Applicant: Ari Kugler, Westmount (CA)

(72) Inventor: Ari Kugler, Westmount (CA)

(21) Appl. No.: 15/403,641

(22) Filed: Jan. 11, 2017

Related U.S. Application Data
(60) Provisional application No. 62/277,699, filed on Jan. 12, 2016.
(60) Provisional application No. 62/298,500, filed on Feb. 23, 2016.

(51) Int. Cl. G06Q 30/02

(52) U.S. Cl. CPC G06Q 30/0261; G06Q 30/0277; G06Q 50/30

(57) ABSTRACT

A method and a system for enabling a user of a multi-user transportation system to initiate a transaction for at least one of a good and a service offered by a third party, the method comprising providing each user of the multi-user transportation system with an application running on a corresponding mobile processing device, wherein the application is used for identifying a corresponding itinerary taken by a corresponding user amongst a plurality of itineraries in the multi-user transportation system; providing an interface for enabling a third party to provide at least one advertisement offer, wherein the providing of the at least one advertisement offer comprises providing at least one of a location-based target criterion and an indication of a corresponding advertisement; estimating a current position of a plurality of users using at least the itinerary identified and the application; identifying a group of at least one target user using the location-based target criterion and the corresponding estimated positions; providing at least one corresponding advertisement to each of the at least one target user and providing an interface for initiating a transaction associated with the provided at least one corresponding advertisement.

### CROSS-REFERENCE TO RELATED APPLICATIONS

The present patent application claims priority on U.S. Provisional Patent Applications No. 62/277,699, filed on Jan. 12, 2016, and No. 62/298,500, filed on Feb. 23, 2016, the subject matter of which is incorporated herein by reference.

### FIELD

The invention relates to computers. More precisely, this invention relates to a method and system for enabling a user of a multi-user transportation system to initiate a transaction for at least one of a good and a service offered by a third party and use thereof.

### BACKGROUND

Being able to target a user for a product or a service at a certain time and or a certain place is very desirable.

Many solutions are provided to try to achieve such goal but unfortunately they suffer from many limitations.

For instance, a first limitation is that it may be difficult to predict where the user will be, or at what time the user will be, or what he may do in the near future.

Another limitation is that it may then be cumbersome to engage the user in a transaction.

There is therefore a need for a method and system that will overcome at least one of the above-identified drawbacks.

Features of the invention will be apparent from review of the disclosure, drawings and description of the invention below.

### BRIEF SUMMARY

According to a broad aspect, there is disclosed a method for enabling a user of a multi-user transportation system to initiate a transaction for at least one of a good and a service offered by a third party, the user carrying a mobile processing device, the method comprising providing each user of a plurality of users of the multi-user transportation system with an application running on a corresponding mobile processing device, wherein the application is used in conjunction with a remote server operatively connected to the plurality of mobile processing devices for identifying a corresponding itinerary taken by a corresponding user amongst a plurality of itineraries in the multi-user transportation system; providing an interface for enabling a third party to provide at least one advertisement offer for at least one of a good and a service, wherein the providing of the at least one advertisement offer comprises providing at least one of a location-based target criterion and an indication of a corresponding advertisement; estimating a current position of a plurality of users using at least the itinerary identified and the application; identifying a group of at least one target user amongst the plurality of users using the location-based target criterion and the corresponding estimated positions; providing at least one corresponding advertisement to each of the at least one target user and providing an interface for initiating a transaction associated with the provided at least one corresponding advertisement to each of the at least one target user via the corresponding application.

According to an embodiment, the providing of the at least one advertisement offer further comprises providing a time-based criterion and the identifying of a group of at least one target user amongst the plurality of users is further performed using the time-based criterion.

According to an embodiment, the multi-user transportation system is selected from a group consisting of at least one of a subway system, a railroad system, a bus system, a public bike-sharing system, a system comprising a network of taxis, a system offering a ride-sharing service and a system offering a vehicle sharing service.

According to an embodiment, the providing of an interface for enabling a third party to provide at least one advertisement offer for at least one of a good and a service comprises accessing a website.

According to an embodiment, the location-based target criterion is provided by the third party on the interface.

According to an embodiment, the least one location-based target criterion is selected from a group consisting of at least one of a geographic location defined using geographic coordinates and a geographic zone defined using a plurality of geographic coordinates.

According to an embodiment, the providing of the at least one advertisement offer further comprises providing at least one of a time-based target criterion, a user-based target criterion and an environment-based target criterion.

According to an embodiment, a time-based target criterion is provided by the third party and the time-based target criterion is selected from a group consisting of a precise temporal indication and a duration starting or finishing at a precise temporal indication and the time-based target criterion is used for identifying a group of at least one target user amongst the plurality of users.

According to an embodiment, a user-based target criterion is provided by the third party; the user-based target criterion is related to at least one characteristic of a target user and the user-based target criterion is used for identifying a group of at least one target user amongst the plurality of users.

According to an embodiment, a user-based target criterion is provided by the third party; the user-based target criterion is based on previous data associated with a target user and the user-based target criterion is used for identifying a group of at least one target user amongst the plurality of users.

According to an embodiment, the previous data associated with a target user comprises target user travel data patterns.

According to an embodiment, an environment-based target criterion is provided; the environment-based target criterion is related to an element surrounding the target user and the environment-based target criterion is used for identifying a group of at least one target user amongst the plurality of users.

According to an embodiment, the element surrounding the target user is selected from a group consisting of a current weather around the target user, a scheduled weather around the target user and a traffic around the target user.

According to an embodiment, the at least one corresponding advertisement is provided to each of the at least one target user using at least one of the application running on each of the at least one target user mobile processing device, a short message service (SMS) message and an email transmitted to each of the at least one target user.

According to an embodiment, the providing of an interface for initiating a transaction associated with the provided at least one corresponding advertisement comprises displaying a visual indication for initiating a transaction.

According to an embodiment, the visual indication for initiating a transaction comprises at least one of a text, a logo, an icon and a picture.

According to an embodiment, the visual indication for initiating a transaction further comprises a hyperlink for creating a connection between a given user mobile processing device and a given processing device used for performing the transaction.

According to an embodiment, the method further comprises initiating the transaction upon detection of an interaction with the visual indication for initiating a transaction.

According to an embodiment, the initiating of the transaction comprises accessing the given processing device used for performing the transaction.

According to an embodiment, the accessing of the given processing device used for performing the transaction comprises using user profile data for authenticating the user.

According to a broad aspect, there is disclosed a non-transitory computer-readable storage medium for storing computer-executable instructions which, when executed, cause a processing device to perform a method for enabling a user of a multi-user transportation system to initiate a transaction for at least one of a good and a service offered by a third party, the user carrying a mobile processing device, the method comprising providing each user of a plurality of users of the multi-user transportation system with an application running on a corresponding mobile processing device, wherein the application is used in conjunction with a remote server operatively connected to the plurality of mobile processing devices for identifying a corresponding itinerary taken by a corresponding user amongst a plurality of itineraries in the multi-user transportation system; providing an interface for enabling a third party to provide at least one advertisement offer for at least one of a good and a service, wherein the providing of the at least one advertisement offer comprises providing at least one of a location-based target criterion and an indication of a corresponding advertisement; estimating a current position of a plurality of users using at least the itinerary identified and the application; identifying a group of at least one target user amongst the plurality of users using the location-based target criterion and the corresponding estimated positions; providing at least one corresponding advertisement to each of the at least one target user via the corresponding application; and providing an interface for initiating a transaction associated with the provided at least one corresponding advertisement to each of the at least one target user via the corresponding application.

According to a broad aspect, there is disclosed a processing device comprising a central processing unit; a display device; a communication port for operatively connecting the processing device to a plurality of mobile processing devices, each carried by a user; a memory unit comprising an application for providing an advertisement, the application comprising instructions for providing an interface for enabling a third party to provide at least one advertisement offer for at least one of a good and a service; instructions for estimating a current position of a plurality of users using at least an itinerary identified and the application; instructions for identifying a group of at least one target user amongst the plurality of users using a location-based target criterion and the corresponding estimated positions; instructions for providing at least one corresponding advertisement to each of the at least one target user via the corresponding application; instructions for providing an interface for initiating a transaction associated with the provided at least one corresponding advertisement to each of the at least one target user via the corresponding application.

An advantage of the method disclosed is that it enables a third party to precisely target at least one target user based on an itinerary taken in a multi-user transportation system.

An advantage of the method disclosed is that it enables a third party to provide at least one advertisement offer based on predicted future location and/or user's preferences or patterns.

Another advantage of the method disclosed is that it facilitates the performing of a transaction while in transit. In fact, prior-art methods for performing a transaction may be time-consuming or cumbersome and require a lot of input from the user, which is not desirable when the user is in transit.

Another advantage of the method disclosed is that it may be advantageously used for delivering goods or services that are pertinent to a user at a certain time and a certain location.

Another advantage of the method disclosed is that it may enable a user to initiate a transaction following the receiving of an advertisement using a minimum interaction from the user which is of great interest.

### BRIEF DESCRIPTION OF THE DRAWINGS

In order that the invention may be readily understood, embodiments of the invention are illustrated by way of example in the accompanying drawings.

FIG. 1 is a flowchart that shows an embodiment of a method for enabling a user of a multi-user transportation system to initiate a transaction for at least one of a good and a service offered by a third party;

FIG. 2 is a block diagram that shows a first embodiment of a system in which the method for enabling a user of a multi-user transportation system to initiate a transaction for at least one of a good and a service offered by a third party may be implemented;

FIG. 3 is a block diagram that shows a second embodiment of a system in which the method for enabling a user of a multi-user transportation system to initiate a transaction for at least one of a good and a service offered by a third party may be implemented;

FIG. 4 is a diagram that shows an embodiment of a processing device for providing an advertisement;

FIG. 5 is a flowchart that shows an embodiment for providing each user with an application on a corresponding mobile processing device;

FIG. 6 is a flowchart that shows a second embodiment for providing an interface for enabling a third party to provide an advertisement;

FIG. 7 is a flowchart that shows an embodiment for identifying a group of at least one target user;

FIG. 8 is a flowchart that shows an embodiment for providing a corresponding advertisement to the users of the group;

FIG. 9 is a flowchart that shows an embodiment for providing the users of a group with an interface for initiating a transaction;

FIG. 10 is a flowchart that shows an embodiment for initiating a transaction in response to a detection of an interaction;

FIG. 11 is a screenshot that shows an embodiment of user interface for enabling a third party to provide at least one advertisement offer to a user.

FIG. 12a is a screenshot that shows an embodiment of a user interface displaying a plurality of advertisements to a user.

FIG. 12b is a screenshot that shows an embodiment of a user interface displaying a single advertisement to a user.

FIG. 13 is a screenshot that shows an embodiment of a user interface displaying a single advertisement to a user.

Further details of the invention and its advantages will be apparent from the detailed description included below.

### DETAILED DESCRIPTION

In the following description of the embodiments, references to the accompanying drawings are by way of illustration of an example by which the invention may be practiced.

### Terms

The term “invention” and the like mean “the one or more inventions disclosed in this application,” unless expressly specified otherwise.

The terms “an aspect,” “an embodiment,” “embodiment,” “embodiments,” “the embodiment,” “the embodiments,” “one or more embodiments,” “some embodiments,” “certain embodiments,” “one embodiment,” “another embodiment” and the like mean “one or more (but not all) embodiments of the disclosed invention(s),” unless expressly specified otherwise.

A reference to “another embodiment” or “another aspect” in describing an embodiment does not imply that the referenced embodiment is mutually exclusive with another embodiment (e.g., an embodiment described before the referenced embodiment), unless expressly specified otherwise.

The terms “including,” “comprising” and variations thereof mean “including but not limited to,” unless expressly specified otherwise.

The terms “a,” “an” and “the” mean “one or more,” unless expressly specified otherwise.

The term “plurality” means “two or more,” unless expressly specified otherwise.

The term “herein” means “in the present application, including anything which may be incorporated by reference,” unless expressly specified otherwise.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms mean “for example,” and thus do not limit the terms or phrases they explain. For example, in a sentence “the computer sends data (e.g., instructions, a data structure) over the Internet,” the term “e.g.” explains that “instructions” are an example of “data” that the computer may send over the Internet, and also explains that “a data structure” is an example of “data” that the computer may send over the Internet. However, both “instructions” and “a data structure” are merely examples of “data,” and other things besides “instructions” and “a data structure” can be “data.”

The term “i.e.” and like terms mean “that is,” and thus limit the terms or phrases they explain.

The term “multi-user transportation system” and like terms mean a system providing or facilitating the providing of transportation to a plurality of users. The system may be privately operated or publicly operated. In one embodiment, the multi-user transportation system is selected from a group consisting of at least one of a subway system, a railroad system, a bus system, public bike-sharing system, a system comprising a network of taxis, and the like. Alternatively, the system may be an application for facilitating the providing of transportation to a plurality of users such as, for instance, Uber™.

The term “advertisement” and like terms mean a notice used for promoting at least one of a good and a service or a notice used for persuading a user to initiate a transaction for at least one of a good and a service.

The term “transaction” means a communicative action or activity involving at least two parties that reciprocally affect or influence each other. For instance the transaction may involve an exchange of at least one of a good and a service for a given consideration to be provided at the time of the exchange or at another time. The good may be a physical good or a right to a real or virtual currency. The service may be a physical service or a right to access a digital media providing service such as for instance a digital media providing service enabling an access to a music streaming service, a video streaming service or a database of texts.

The term “initiating” means to start the process of performing a transaction.

Neither the Title nor the Abstract is to be taken as limiting in any way as the scope of the disclosed invention(s). The title of the present application and headings of sections provided in the present application are for convenience only, and are not to be taken as limiting the disclosure in any way.

Numerous embodiments are described in the present application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural and logical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

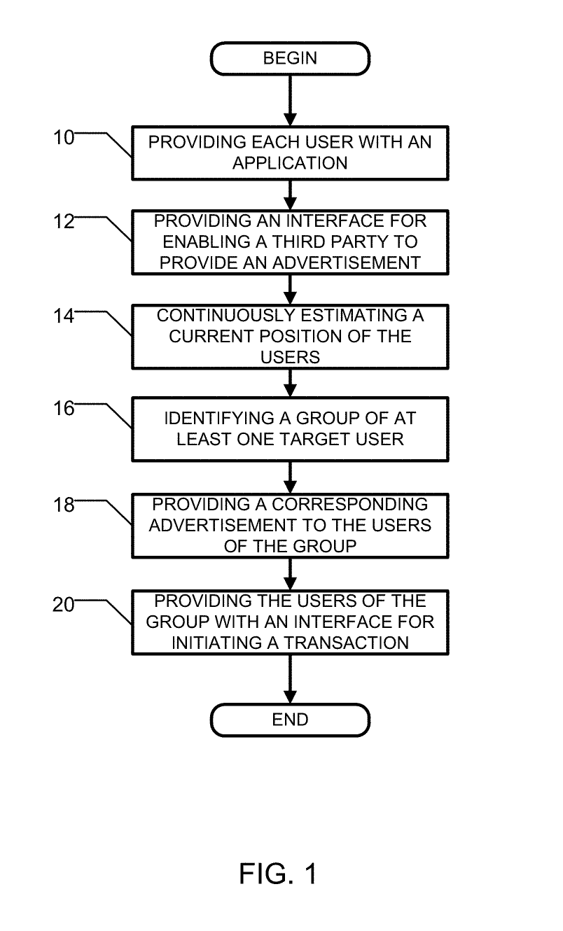

Now referring to FIG. 1, there is shown an embodiment of a method for enabling a user of a multi-user transportation system to initiate a transaction for at least one of a good and a service offered by a third party. It will be appreciated that the user is carrying a mobile processing device.

As mentioned above, it will be appreciated that the multi-user transportation system may be of various types.

In one embodiment, the multi-user transportation system is selected from a group consisting of at least one of a subway system, a railroad system, a bus system, public bike-sharing system, a system comprising a network of taxis, a system offering a ride-sharing service, system offering a vehicle sharing service and the like.

In one embodiment, the multi-user transportation system comprises a network composed of a subway system and a bus system of a given city.

As known to the skilled addressee, it will be appreciated that the size of a multi-user transportation system may greatly vary depending on a geographic location. Moreover, it will be appreciated that the coverage of a multi-user transportation system may not be limited to a given specific area. In fact, the multi-user transportation system may be deployed in at least one of a city, a city and a suburb, a department, a region, a country, and a continent.

It will be appreciated that the mobile processing device may be carried by the user according to various embodiments.

In one embodiment, the mobile processing device is carried by the user in a way that is visible to him/her.

In an alternative embodiment, the mobile processing device is concealed from the view of the user and may be, for instance, located in a pocket of a garment worn by the user.

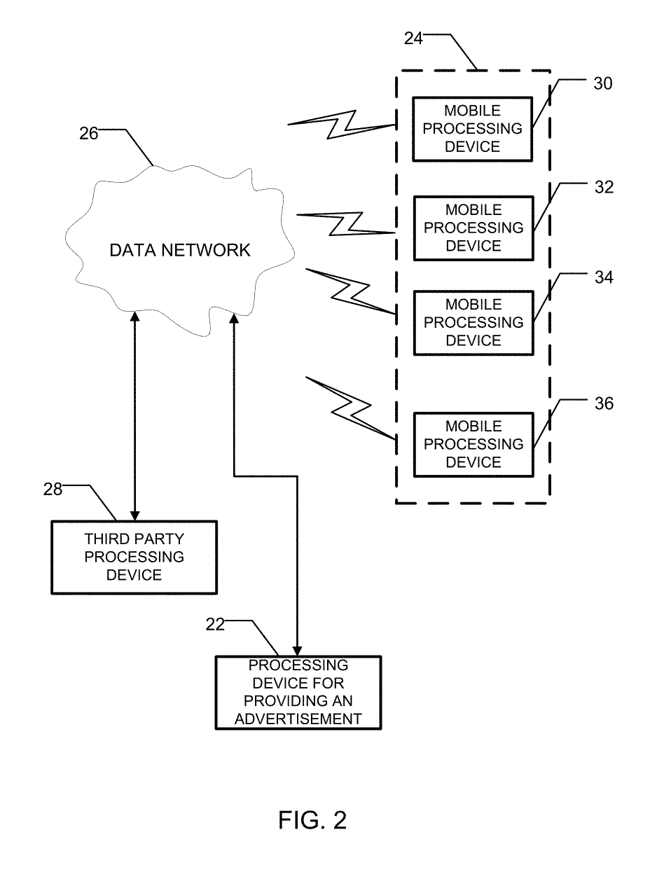

Now referring to FIG. 2, there is shown a first embodiment of a system in which the method for enabling a user of a multi-user transportation system to initiate a transaction for at least one of a good and a service offered by a third party may be implemented.

The system comprises a processing device for providing an advertisement 22, a plurality of mobile processing devices 24, a data network 26 and a third party processing device 28. It will be appreciated that the processing device for providing an advertisement 22 may be referred to as a loyalty program processing device in the co-pending U.S. Patent Application No. 62/277,699, entitled “Method and System for Providing a Loyalty Program to a User of a Multi-User Transportation System and Use Thereof,” which was filed on Jan. 12, 2016. In fact, it will be appreciated by the skilled addressee that a single processing device may be used for providing both functionalities.

The processing device for providing an advertisement 22 is used for providing an advertisement to a group of at least one target user of a plurality of users of a given multi-user transportation system.

It will be appreciated that the processing device for providing an advertisement 22 may be of various types.

In one embodiment, the processing device for providing an advertisement 22 is selected from a group consisting of laptop computer, desktop computer, servers, etc.

In a preferred embodiment, the processing device for providing an advertisement 22 comprises a server.

The plurality of mobile processing devices 24 comprises a first mobile processing device 30, a second mobile processing device 32, a third mobile processing device 34, and an N^{th} mobile processing device 36. Each of the first mobile processing device 30, the second mobile processing device 32, the third mobile processing device 34, and the N^{th} mobile processing device 36 is operatively connected with a data network 26.

It will be further appreciated that each of the plurality of mobile processing devices 24 may be selected from a group consisting of smartphones, PDAs, tablet PCs and electronic watches.

In a one embodiment, the plurality of mobile processing devices 24 is wirelessly connected to the data network 26.

It will be further appreciated that each of the plurality of mobile processing device 24 is carried by a corresponding user using the multi-user transportation system.

The third-party processing device 28 is used by a third party to provide data to the processing device for providing an advertisement 22.

The third-party processing device 28 is used to provide the data to the processing device for providing an advertisement 22 via the data network 26.

It will be appreciated that the third-party processing device 28 may be connected to the data network 26 according to various embodiments.

Similarly, it will be appreciated that the processing device for providing an advertisement 22 is connected to the data network 26 according to various embodiments.

It will be appreciated that the data network 26 may be of various types.

In one embodiment, the data network 26 is selected from a group consisting of a local area network (LAN), a metropolitan area network (MAN) and a wide area network (WAN).

In one embodiment, the data network 26 comprises the Internet.

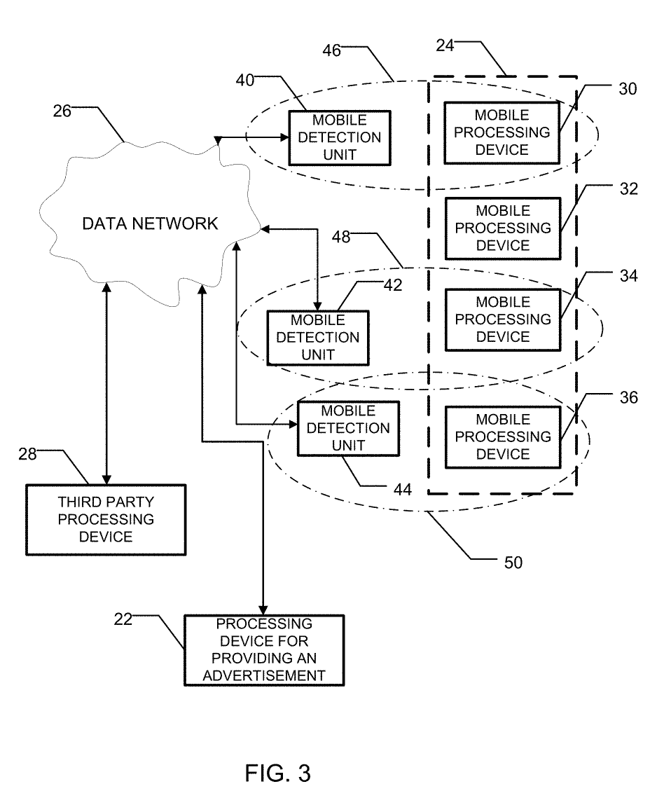

Now referring to FIG. 3, there is shown another embodiment of a system in which the method for enabling a user of a multi-user transportation system to initiate a transaction for at least one of a good and a service offered by a third party may be implemented.

In this embodiment, the system comprises a first mobile detection unit 40, a second mobile detection unit 42 and a third mobile detection unit 44.

Each of the first mobile detection unit 40, the second mobile detection unit 42 and the third mobile detection unit 44 has a dedicated corresponding area labeled respectively 46, 48 and 50 for detecting at least one mobile processing device therein.

In case of a detection, the mobile detection unit will provide a signal indicative of detection to the processing device for providing an advertisement 22.

The signal indicative of detection will be provided by the mobile detection unit to the processing device for providing an advertisement 22 via the data network 26.

It will be appreciated that the mobile detection unit may be connected to the data network 26 according to various embodiments.

As shown in FIG. 3, the first mobile detection unit 40 is capable of detecting the first mobile processing device 30 of the plurality of mobile processing devices 24.

The second mobile detection unit 42 is capable of detecting the third mobile processing device 343 of the plurality of mobile processing devices 24, while the third mobile detection unit 44 is capable of detecting the N^{th} mobile processing device 36 of the plurality of mobile processing devices 24.

It will be appreciated that each of the first mobile detection unit 40, the second mobile detection unit 42 and the third mobile detection unit 44 may be located at a strategic location within the multi-user transportation system.

A strategic location is defined as a location which can be used in the process for determining a trip made by the user.

In the case where the multi-user transportation system is a bus network, the mobile detection units may be located in at least one of a bus stop and a bus.

The skilled addressee will appreciate that various alternative embodiments may be possible.

For instance, the mobile detection units may be located at fixed locations. Alternatively, the mobile detection units may be other mobile processing devices having position-providing capabilities.

As such, the mobile detection unit will be capable of detecting a presence of a corresponding mobile processing device within its range. The skilled addressee will appreciate that the providing of a mobile detection unit will remove the need for the mobile processing device to have a device for providing an indication of the location of the mobile processing device.

Now referring back to FIG. 1 and according to processing step 10, each user is provided with an application. It will be appreciated that the application is provided to the mobile processing device and is adapted for communicating with at least the processing device for providing an advertisement 22 as well as with any mobile detection unit if a mobile detection unit is provided as in FIG. 3.

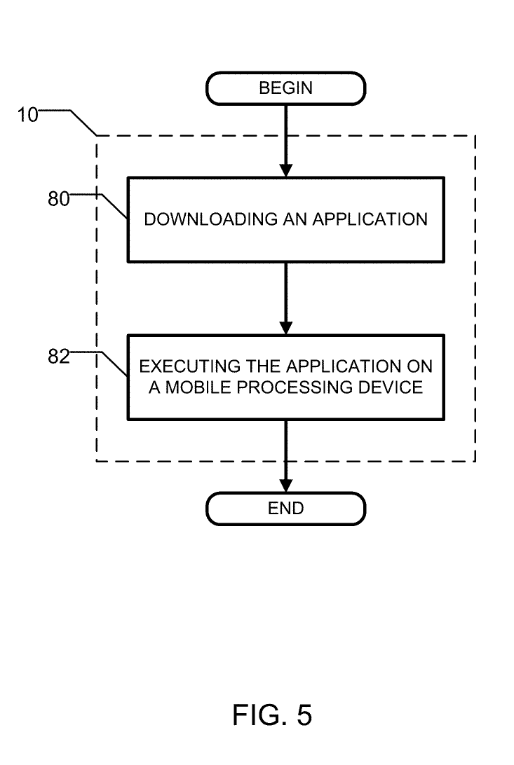

More precisely and now referring to FIG. 5, there is shown an embodiment for providing each user with an application.

According to processing step 80, an application is downloaded from a remote processing device, not shown in FIG. 2 or 3, via a data network 26, such as the Internet for instance.

It will be appreciated that the application may be downloaded according to various embodiments.

In one embodiment, the application is downloaded from an application store such the Apple™ Store.

The skilled addressee will appreciate that many alternative embodiments may be provided for providing the application to the mobile processing device.

Still referring to FIG. 5 and according to processing step 82, the application is executed. It will be appreciated that the application is executed on the mobile processing device of the user.

It will be appreciated that in one embodiment the purpose of the application is first to gather data in order to determine an itinerary followed by the user in the multi-user transportation system. At least one part of the data is provided to the processing device for providing an advertisement to identify an itinerary followed. A second purpose of the application is to provide an interface for providing at least one advertisement to the user using advertisement data provided by the processing device for providing an advertisement. The skilled addressee will appreciate that the application may be implemented according to various embodiments.

Now referring back to FIG. 1 and according to processing step 12, an interface is provided for enabling a third party to provide an advertisement to be transmitted to a group of at least one target user.

It will be appreciated that the interface for enabling a third party to provide an advertisement may be provided according to various embodiments.

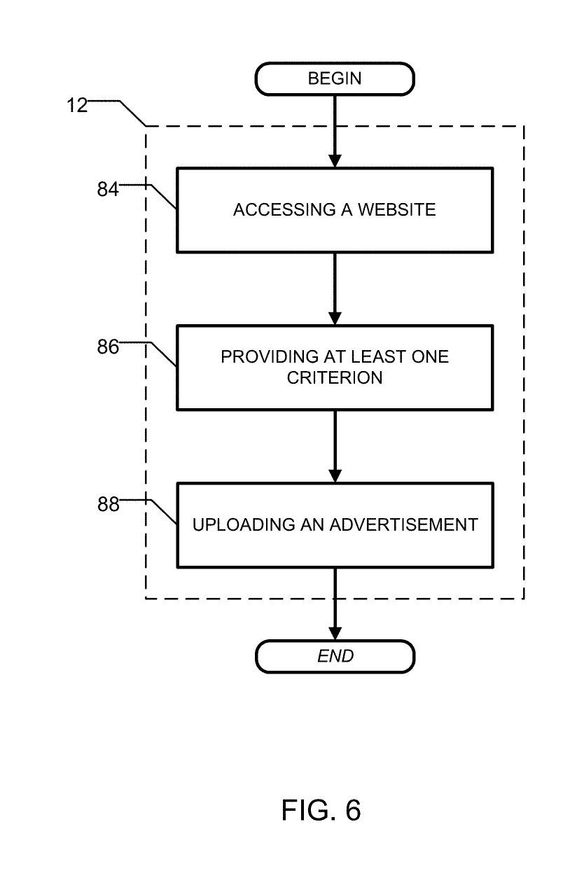

Now referring to FIG. 6, there is shown an embodiment for providing the interface for enabling a third party to provide an advertisement.

According to processing step 84, a website is accessed.

It will be appreciated that the website is hosted by a web server application and is accessed by the third party. In one embodiment, the web server application is hosted by the processing device for providing an advertisement 22 and is accessed by the third party processing device 28 via the data network 26.

In an alternative embodiment, the web server application is hosted by another processing device located at a different location and not shown in FIG. 2 or 3.

According to processing step 86, at least one criterion is provided.

It will be appreciated that the at least one criterion is provided by the third party on the interface displayed on the website.

It will be appreciated that the at least one criterion comprises a location-based target criterion.

The location-based target criterion may be, for instance, a precise geographic location such as one defined using geographic coordinates. The skilled addressee will appreciate that geographic coordinates may be of various forms.

For instance, in one embodiment the geographic coordinates comprise a latitude value and a longitude value.

In an alternative embodiment, the location-based target criterion may be a geographic zone.

It will be appreciated that the geographic zone may be defined using a plurality of geographic coordinates or using a geographic coordinates and additional data. For instance, the geographic zone may be a disc defined around a given geographic coordinate. The skilled addressee will appreciate that any type of zone may be defined accordingly, which is of great advantage.

For instance, a given street of a city, a portion of a given street can be defined as a zone, etc.

The skilled addressee will appreciate that various alternative embodiments may be provided for the location-based target criterion.

In fact, it will be appreciated by the skilled addressee that the at least one criterion may also comprise at least one of a time-based target criterion, a user-based target criterion and an environment-based target criterion.

The time-based target criterion may be for instance a precise temporal indication such as a date and a time.

Alternatively, the temporal indication may be a duration starting or finishing at a precise temporal indication.

The skilled addressee will appreciate that various alternative embodiments may be provided.

Similarly, the user-based target criterion may be of various types. For instance, the user-based target criterion may be related to at least one characteristic of the user profile such as age, sex, residence address, etc.

It will be appreciated that the user-based target criterion may take into consideration past user data. User travel patterns may be derived from the past user data.

The environment-based target criterion may be of various types. In fact, it will be appreciated that the environment-based target criterion is related to an element surrounding, physically or not, the user. The element can be for instance the current or the scheduled weather. Alternatively, the element can be the traffic around the user.

The skilled addressee will appreciate that being able to provide a time-based target criterion, a user-based target criterion and an environment-based target criterion may be of great advantage in order to precisely target users.

According to processing step 88, an advertisement is generated.

It will be appreciated that in one embodiment, the advertisement is generated by the processing device for providing an advertisement.

It will be appreciated that the advertisement is also referred to as an offer. The offer is used for encouraging at least one target user to initiate a transaction for at least one of a good and a service offered by the third party.

It will be appreciated that the advertisement may be generated using advertisement data uploaded according to various embodiments.

In one embodiment, the advertisement data used for generating the advertisement is uploaded by the third party using the third party processing device 28 via the interface generated by the website accessed by the third party.

The advertisement data used for generating the advertisement may be comprised of various data selected from a group consisting of texts, images, logos, pictures, hyperlinks, etc.

In an alternative embodiment, the advertisement data used for generating the advertisement is provided using an email transmitted to the processing device for providing the advertisement. In an alternative embodiment, the advertisement data used for generating the advertisement is provided through incremental and continuous exchange of data between the mobile processing device geo-location and geo special coordinates and the target zones defined in the advertisements. The mobile processing device and the processing device continuously exchange location data and the mobile processing device is updated with a corresponding list of advertisements that have matched those geospatial coordinates for display on the user interface of the application executed on the mobile processing device. It will be appreciated that other parameters may be captured and exchanged between the mobile processing device and the processing device, including time of day, date, as well as user parameters that can be used to filter and target the user's mobile processing device.

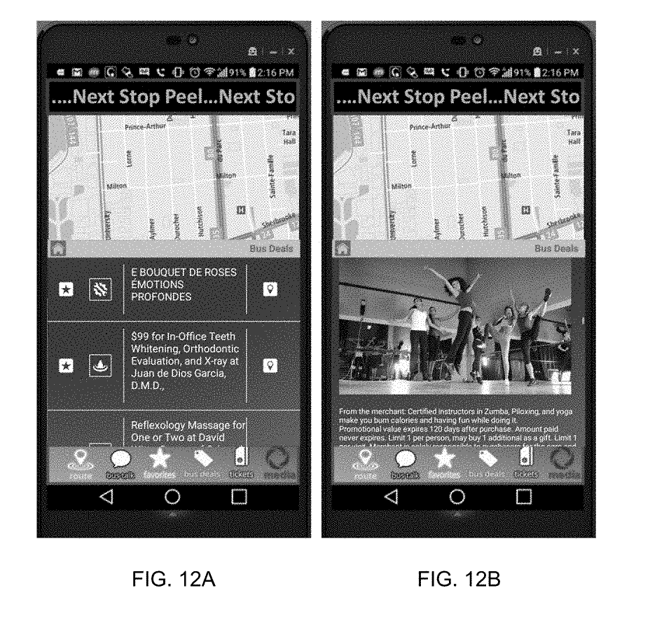

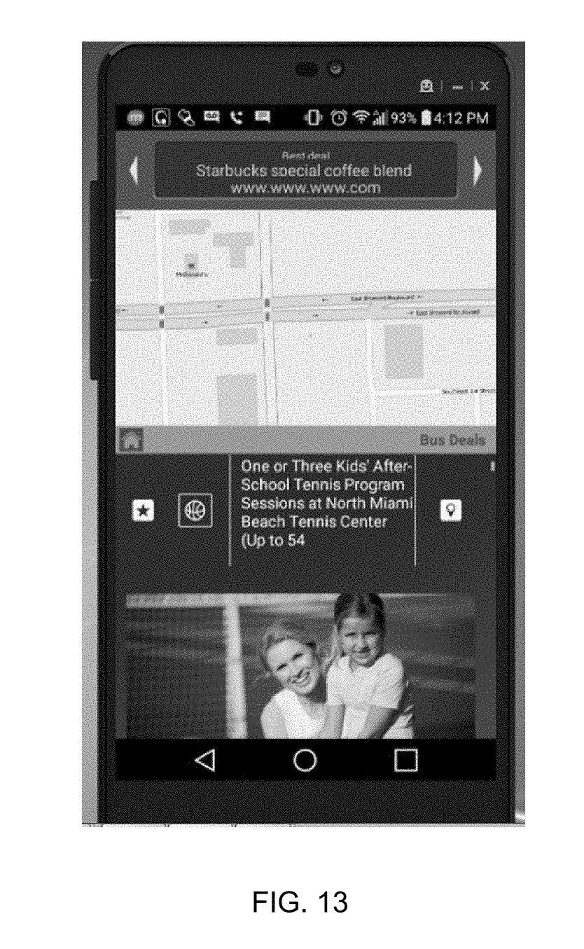

Now referring to FIGS. 12a, 12b and 13, there are shown three embodiments of a user interface displaying a plurality of advertisements.

More precisely, FIG. 12a discloses a user interface displaying a plurality of advertisements, while FIG. 12b discloses a user interface showing a single advertisement. FIG. 13 discloses a user interface showing a single advertisement.

Now referring back to FIG. 1 and according to processing step 14, a current position of the user is estimated.

It will be appreciated that the current position of the user may be estimated continuously. It will be appreciated that the current position may be estimated continuously according to various embodiments.

Alternatively, the current position is determined at a given time.

It will also be appreciated that the current position of the user may be defined according to various embodiments. For instance and in one embodiment, the current position comprises geographic coordinates.

In an alternative embodiment, the current position comprises an indication of an itinerary identified for the user.

The determining of the current position of the user may be done in accordance with the method disclosed in co-pending patent application No. 62/277,699, entitled “Method and System for Providing a Loyalty Program to a User of a Multi-User Transportation System and Use Thereof” and which was filed on Jan. 13, 2016.

Still referring to FIG. 1 and according to processing step 16, a group of at least one target user is identified.

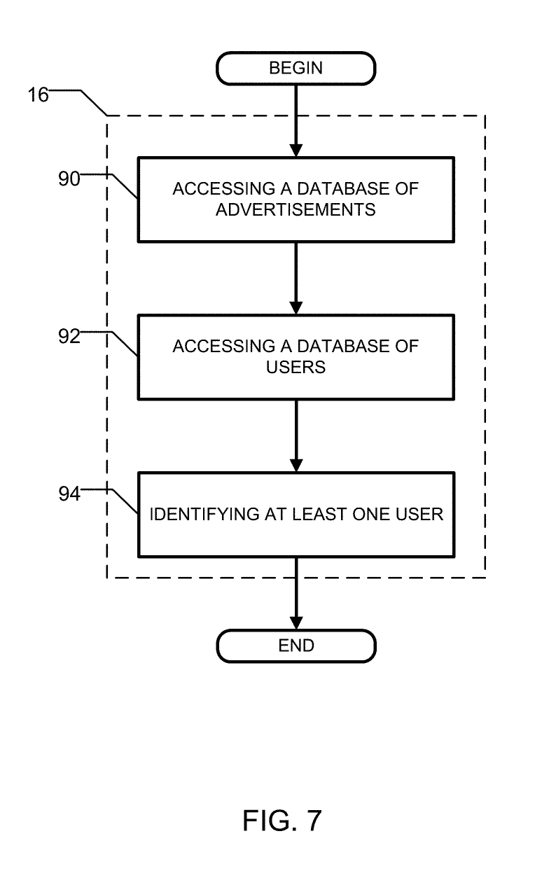

Now referring to FIG. 7, there is shown an embodiment for identifying a group of at least one target user.

The group of at least one target user is defined as a group of at least one user of the plurality of users of the multi-user transportation system that matches the at least one criterion that has been defined by the third party for the advertisement.

The skilled addressee will appreciate that the size of the group of at least one target user may depend on the at least one criterion provided.

According to processing step 90, a database of advertisements is accessed.

It will be appreciated that the database of advertisements is accessed by the processing device for providing an advertisement 22.

It will be appreciated that the database of advertisements may be accessed according to various alternative embodiments.

According to processing step 92, a database of users is accessed.

It will be appreciated that the database of users may be accessed according to various embodiments.

In one embodiment, the database of users is accessed by the processing device for providing an advertisement 22.

Now referring to processing step 94, a group of at least one target user is identified.

It will be appreciated that the at least one user is identified according to various embodiments.

In one embodiment, the at least one user is identified using the processing device for providing an advertisement 22.

In fact, it will be appreciated that the purpose of the identifying is to determine at least one target user that matches the at least one location-based criterion of the database of advertisements.

In the case where at least one other criterion has been provided when generating the advertisement, the at least one target user is determined so that each user matches the criteria.

Now referring back to FIG. 1 and according to processing 18, a corresponding advertisement is provided to each user of the group of the at least one target user.

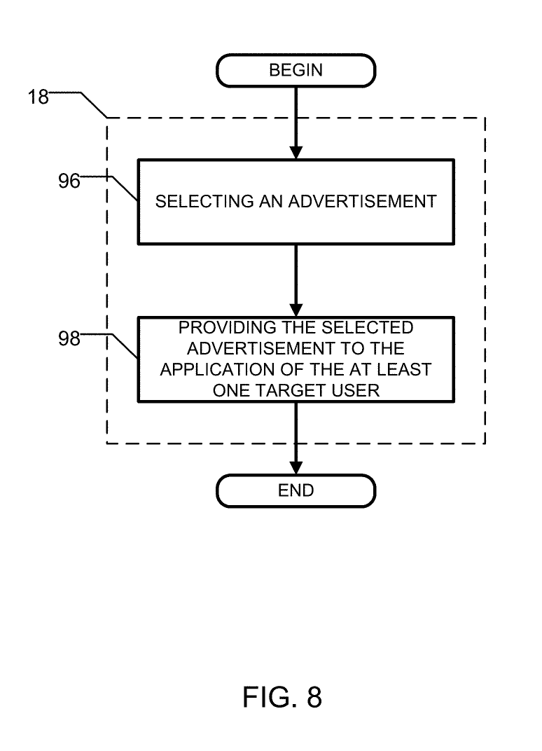

Now referring to FIG. 8, there is shown an embodiment for providing a corresponding advertisement to the at least one user of the group of at least one target user.

According to processing step 96, a corresponding advertisement is selected.

It will be appreciated that the advertisement is selected according to various embodiments.

In one embodiment, the advertisement is selected by the processing device for providing an advertisement 22 in the advertisement database.

It will be appreciated that the selection may comprise performing a filtering of the advertisement based on at least one additional criterion.

According to processing step 98, the selected advertisement is provided to the user.

In one embodiment, the advertisement is provided to the application of the at least one target user.

In such embodiment, the advertisement is displayed on the user interface of the application.

In an alternative embodiment, the advertisement is provided in a short message service (SMS) message transmitted to the user.

In a further alternative embodiment, the advertisement is provided in an email transmitted to the user.

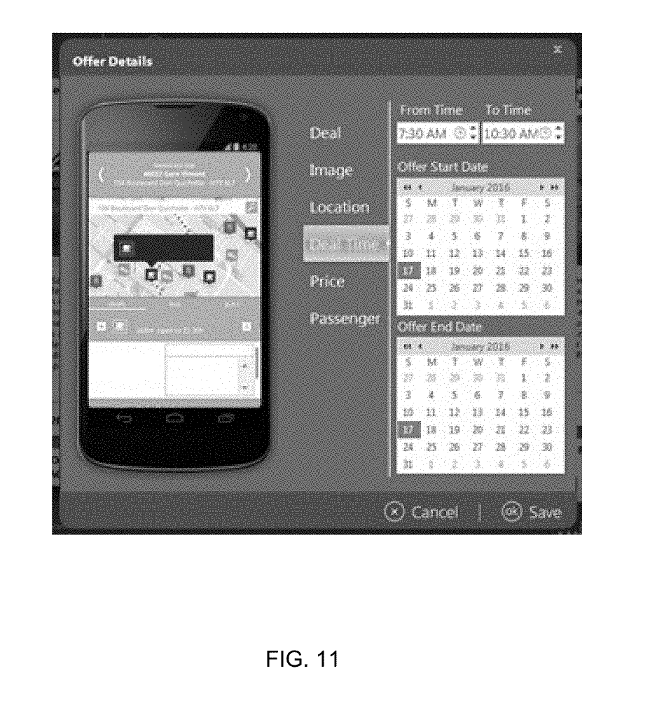

Now referring to FIG. 11, there is shown an embodiment of an advertisement displayed on a user interface of the application executed on the user mobile processing device.

The skilled addressee will appreciate that the advertisement may be displayed according to various embodiments.

Now referring back to FIG. 1 and according to processing step 20, each user of the group of at least one target user is provided with an interface for initiating a transaction.

The purpose of the interface is to initiate a transaction associated with the advertisement delivered to the user.

It will be appreciated that the user of the group of at least one target user may be provided with an interface for initiating a transaction according to various embodiments.

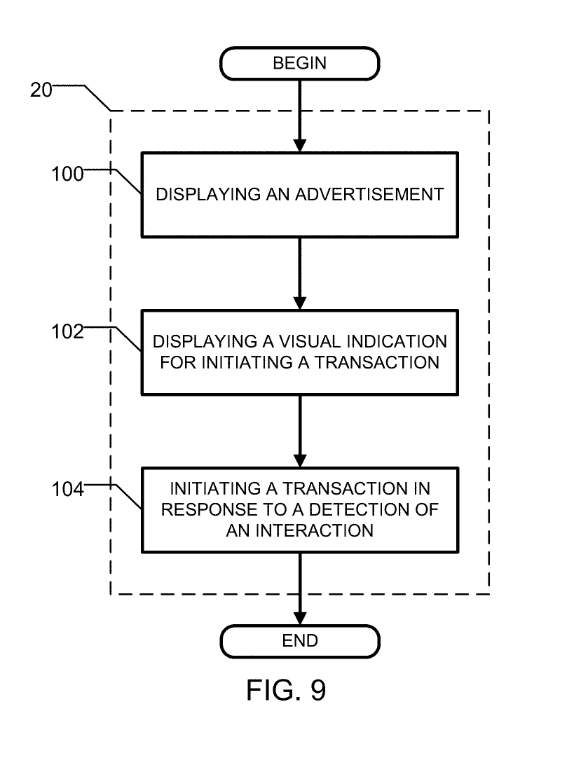

Now referring to FIG. 9, there is shown an embodiment for providing the user of the group of at least one target user with an interface for initiating a transaction.

According to processing step 100, an advertisement is displayed.

It will be appreciated that the advertisement may be displayed according to various embodiments as explained above. For instance, the advertisement may be displayed on an interface of the application.

An example of such embodiment is shown for instance in FIGS. 12a, 12b and 13.

According to processing step 102, a visual indication is displayed for initiating a transaction.

It will be appreciated that the visual indication for initiating a transaction may be displayed according to various embodiments.

In one embodiment, the visual indication for initiating a transaction is displayed within the advertisement.

In an alternative embodiment, the visual indication for initiating a transaction is displayed next to the advertisement.

It will be appreciated that the visual indication may be of various types.

For instance the visual indication may comprise a combination of at least one of a text, a logo, an icon, a picture, etc.

In one embodiment, the visual indication further comprises a hyperlink associated therewith. It will be appreciated that the hyperlink may be used in one embodiment for creating a connection between user mobile processing device and another processing device used for performing the transaction.

In the embodiment shown in FIG. 13, the visual indication comprises in icon with a hyperlink attached to it. The skilled addressee will appreciate that various alternative embodiment may be possible. In the present embodiment shown in FIG. 13, the third party is a tennis school located near the route of the user. The tennis school will advantageously use the system disclosed herein to display an advertisement offering a special session or lesson at a specific time to the user.

According to processing step 104, a transaction is initiated in response to a detection of an interaction from the user.

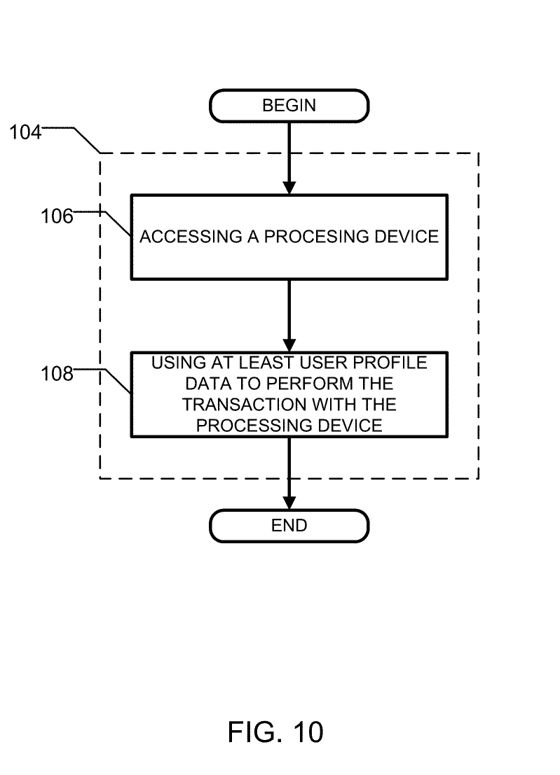

Now referring to FIG. 10, there is shown an embodiment for initiating a transaction in response to a detection of an interaction from the user.

According to processing step 106, a processing device is accessed.

It will be appreciated that in one embodiment, the processing device accessed is a processing device associated with the third party such as, for instance, a third-party website operated directly or indirectly by the third party.

In an alternative embodiment, the processing device accessed is the processing device for providing an advertisement 22.

This may be the case if the third party does not want to be involved with the transaction.

It will be appreciated that the processing device may be accessed according to various alternative embodiments.

Still referring to FIG. 10 and according to processing step 108, at least one user profile data is used in order to perform a transaction with the accessed processing device.

It will be appreciated that this processing step may be performed according to various embodiments.

In fact, it will be appreciated that the user profile data may be advantageously used for performing the transaction.

For instance, the use of the user profile data may be used for authenticating the user.

It will be appreciated that the user profile data may be stored in the database of users.

Alternatively, the user profile data may be used to prevent the user from having to enter data already available, which is of great advantage in a mobile environment.

Using such embodiment, the user will have only limited amount of information to provide for performing the transaction, if any.

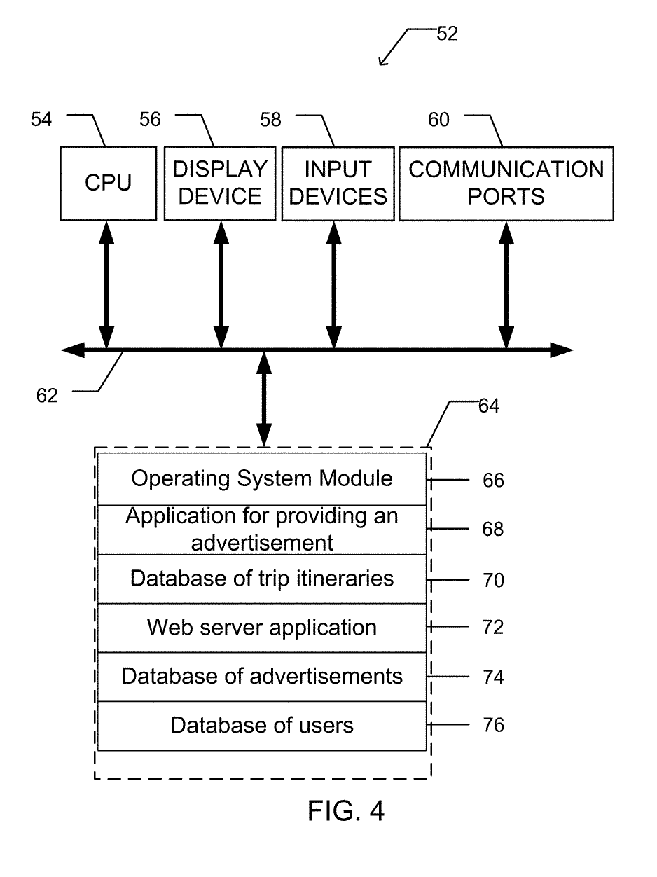

Now referring to FIG. 4, there is shown an embodiment of a processing device for providing an advertisement 22.

The processing device for providing an advertisement 22 comprises a central processing unit 54, a display device 56, input devices 58, communication ports 60, a data bus 62 and a memory unit 64.

The central processing unit 54, the display device 56, the input devices 58, the communication ports 60 and the memory unit 64 are interconnected using the data bus 62.

The central processing unit 54 is used for processing computer instructions. The skilled addressee will appreciate that various embodiments of the central processing unit 54 may be provided.

In one embodiment, the central processing unit 54 is a CPU Core i7 3820 running at 3.6 GHz and manufactured by Intel™.

The display device 56 is used for displaying data to a user. The skilled addressee will appreciate that various types of display device 56 may be used.

In one embodiment, the display device 56 is a standard liquid-crystal display (LCD) monitor.

The communication ports 60 are used for sharing data with the processing device for providing an advertisement 22.

The communication ports 60 may comprise, for instance, a universal serial bus (USB) port for connecting a keyboard and a mouse to the processing device for providing an advertisement 22.

The communication ports 60 may further comprise a data network communication port such as an IEEE 802.3 port for enabling a connection of the processing device for providing an advertisement 22 with another processing device via a data network 26.

The skilled addressee will appreciate that various alternative embodiments of the communication ports 60 may be provided.

In one embodiment, the communication ports 60 comprise an Ethernet port and a mouse port (e.g., Logitech™).

The memory unit 64 is used for storing computer-executable instructions.

It will be appreciated that the memory unit 64 comprises, in one embodiment, an operating system module 66.

It will be appreciated by the skilled addressee that the operating system module 66 may be of various types.

In an embodiment, the operating system module 66 is Windows™ 8 manufactured by Microsoft™.

The memory unit 64 further comprises an application for providing an advertisement 68.

The memory unit 64 further comprises a database of trip itineraries 70.

In fact, it will be appreciated that the database of trip itinerary 70 may further comprise any type of data necessary for correlating a user to a given itinerary.

The memory unit 64 further comprises a web server application 72.

It will be appreciated that the webserver application 72 may be of various types.

The memory unit 64 further comprises a database of advertisements 74.

The memory unit 64 further comprises a database of users 76.

The application for providing an advertisement 68 comprises instructions for providing an interface for enabling a third party to provide at least one advertisement offer for at least one of a good and a service.

The application for providing an advertisement 68 further comprises instructions for estimating a current position of a plurality of users using at least the itinerary identified and the application.

The application for providing an advertisement 68 further comprises instructions for identifying a group of at least one target user amongst the plurality of users using a location-based target criterion and the corresponding estimated positions.

The application for providing an advertisement 68 further comprises instructions for providing at least one corresponding advertisement to each of the at least one target user via the corresponding application.

The application for providing an advertisement 68 further comprises instructions for providing an interface for initiating a transaction associated with the provided at least one corresponding advertisement to each of the at least one target user via the corresponding application.

It will be appreciated that a non-transitory computer-readable storage medium is also disclosed for storing computer-executable instructions which, when executed, cause a processing device to perform a method for providing an advertisement to a user of a multi-user transportation system, the user carrying a processing device. The method comprises providing an interface for enabling a third party to provide at least one advertisement offer for at least one of a good and a service; estimating a current position of a plurality of users using at least the itinerary identified and the application; identifying a group of at least one target user amongst the plurality of users using a location-based target criterion and the corresponding estimated positions; providing at least one corresponding advertisement to each of the at least one target user via the corresponding application and providing an interface for initiating a transaction associated with the provided at least one corresponding advertisement to each of the at least one target user via the corresponding application.

It will be appreciated that a non-transitory computer-readable storage medium is also disclosed for storing computer-executable instructions which, when executed, cause a processing device to perform a method for enabling a user of a multi-user transportation system to initiate a transaction for at least one of a good and a service offered by a third party, the user carrying a mobile processing device. The method comprises providing each user of a plurality of users of the multi-user transportation system with an application running on a corresponding mobile processing device, wherein the application is used in conjunction with a remote server operatively connected to the plurality of mobile processing devices for identifying a corresponding itinerary taken by a corresponding user amongst a plurality of itineraries in the multi-user transportation system; providing an interface for enabling a third party to provide at least one advertisement offer for at least one of a good and a service, wherein the providing of the at least one advertisement offer comprises providing at least one of a location-based target criterion and an indication of a corresponding advertisement; estimating a current position of a plurality of users using at least the itinerary identified and the application; identifying a group of at least one target user amongst the plurality of users using the location-based target criterion and the corresponding estimated positions; providing at least one corresponding advertisement to each of the at least one target user via the corresponding application; and providing an interface for initiating a transaction associated with the provided at least one corresponding advertisement to each of the at least one target user via the corresponding application.

Although the above description relates to a specific preferred embodiment as presently contemplated by the inventor, it will be understood that the invention in its broad aspect includes functional equivalents of the elements described herein.

1. A method for enabling a user of a multi-user transportation system to initiate a transaction for at least one of a good and a service offered by a third party, the user carrying a mobile processing device, the method comprising:
providing each user of a plurality of users of the multi-user transportation system with an application running on a corresponding mobile processing device, wherein the application is used in conjunction with a remote server operatively connected to the plurality of mobile processing devices for identifying a corresponding itinerary taken by a corresponding user amongst a plurality of itineraries in the multi-user transportation system;
providing an interface for enabling a third party to provide at least one advertisement offer for at least one of a good and a service, wherein the providing of the at least one advertisement offer comprises providing at least one of a location-based target criterion and an indication of a corresponding advertisement;
estimating a current position of a plurality of users using at least the itinerary identified and the application;
identifying a group of at least one target user amongst the plurality of users using the location-based target criterion and the corresponding estimated positions;
providing at least one corresponding advertisement to each of the at least one target user; and
providing an interface for initiating a transaction associated with the provided at least one corresponding advertisement to each of the at least one target user via the corresponding application.

2. The method as claimed in claim 1, wherein the providing of the at least one advertisement offer further comprises providing a time-based criterion; further wherein the identifying of a group of at least one target user amongst the plurality of users is further performed using the time-based criterion.

3. The method as claimed in claim 1, wherein the multi-user transportation system is selected from a group consisting of at least one of a subway system, a railroad system, a bus system, a public bike-sharing system, a system comprising a network of taxis, a system offering a ride-sharing service and a system offering a vehicle sharing service.

4. The method as claimed in claim 1, wherein the providing of an interface for enabling a third party to provide at least one advertisement offer for at least one of a good and a service comprises accessing a website.

5. The method as claimed in claim 4, wherein the location-based target criterion is provided by the third party on the interface.

6. The method as claimed in claim 4, wherein the least one location-based target criterion is selected from a group consisting of at least one of a geographic location defined using geographic coordinates and a geographic zone defined using a plurality of geographic coordinates.

7. The method as claimed in claim 1, wherein the providing of the at least one advertisement offer further comprises providing at least one of a time-based target criterion, a user-based target criterion and an environment-based target criterion.

8. The method as claimed in claim 7, wherein a time-based target criterion is provided by the third party, further wherein the time-based target criterion is selected from a group consisting of a precise temporal indication and a duration starting or finishing at a precise temporal indication and further wherein the time-based target criterion is used for identifying a group of at least one target user amongst the plurality of users.

9. The method as claimed in claim 7, wherein a user-based target criterion is provided by the third party, further wherein the user-based target criterion is related to at least one characteristic of a target user, further wherein the user-based target criterion is used for identifying a group of at least one target user amongst the plurality of users.

10. The method as claimed in claim 7, wherein a user-based target criterion is provided by the third party, further wherein the user-based target criterion is based on previous data associated with a target user, further wherein the user-based target criterion is used for identifying a group of at least one target user amongst the plurality of users.

11. The method as claimed in claim 10, wherein the previous data associated with a target user comprises target user travel data patterns.

12. The method as claimed in claim 7, wherein an environment-based target criterion is provided, further wherein the environment-based target criterion is related to an element surrounding the target user and further wherein the environment-based target criterion is used for identifying a group of at least one target user amongst the plurality of users

13. The method as claimed in claim 12, wherein the element surrounding the target user is selected from a group consisting of a current weather around the target user, a scheduled weather around the target user and a traffic around the target user.

14. The method as claimed in claim 1, wherein the at least one corresponding advertisement is provided to each of the at least one target user using at least one of the application running on each of the at least one target user mobile processing device, a short message service (SMS) message and an email transmitted to each of the at least one target user.

15. The method as claimed in claim 1, wherein the providing of an interface for initiating a transaction associated with the provided at least one corresponding advertisement comprises displaying a visual indication for initiating a transaction.

16. The method as claimed in claim 15, wherein the visual indication for initiating a transaction comprises at least one of a text, a logo, an icon and a picture.

17. The method as claimed in claim 16, wherein the visual indication for initiating a transaction further comprises a hyperlink for creating a connection between a given user mobile processing device and a given processing device used for performing the transaction.

18. The method as claimed in claim 15, further comprising initiating the transaction upon detection of an interaction with the visual indication for initiating a transaction.

19. The method as claimed in claim 18, wherein the initiating of the transaction comprises accessing the given processing device used for performing the transaction.

20. The method as claimed in claim 19, wherein the accessing of the given processing device used for performing the transaction comprises using user profile data for authenticating the user.

21. A non-transitory computer-readable storage medium for storing computer-executable instructions which, when executed, cause a processing device to perform a method for enabling a user of a multi-user transportation system to initiate a transaction for at least one of a good and a service offered by a third party, the user carrying a mobile processing device, the method comprising:
providing each user of a plurality of users of the multi-user transportation system with an application running on a corresponding mobile processing device, wherein the application is used in conjunction with a remote server operatively connected to the plurality of mobile processing devices for identifying a corresponding itinerary taken by a corresponding user amongst a plurality of itineraries in the multi-user transportation system;
providing an interface for enabling a third party to provide at least one advertisement offer for at least one of a good and a service, wherein the providing of the at least one advertisement offer comprises providing at least one of a location-based target criterion and an indication of a corresponding advertisement;
estimating a current position of a plurality of users using at least the itinerary identified and the application;
identifying a group of at least one target user amongst the plurality of users using the location-based target criterion and the corresponding estimated positions;
providing at least one corresponding advertisement to each of the at least one target user via the corresponding application; and
providing an interface for initiating a transaction associated with the provided at least one corresponding advertisement to each of the at least one target user via the corresponding application.

22. A processing device comprising:
a central processing unit;
a display device;
a communication port for operatively connecting the processing device to a plurality of mobile processing devices, each carried by a user;
a memory unit comprising an application for providing an advertisement, the application comprising:
instructions for providing an interface for enabling a third party to provide at least one advertisement offer for at least one of a good and a service;
instructions for estimating a current position of a plurality of users using at least an itinerary identified and the application;
instructions for identifying a group of at least one target user amongst the plurality of users using a location-based target criterion and the corresponding estimated positions;
instructions for providing at least one corresponding advertisement to each of the at least one target user via the corresponding application;
instructions for providing an interface for initiating a transaction associated with the provided at least one corresponding advertisement to each of the at least one target user via the corresponding application.
